(19) United States
(12) Patent Application Publication
(10) Pub. No.: US 2008/0208752 A1
(43) Pub. Date: Aug. 28, 2008

(54) Content communication and purchase using a computer-based media component

(75) Inventors: Gabriel Gottlieb, Seattle, WA (US); Ken Reneris, Woodinville, WA (US); Bill Chau, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/710,022

(22) Filed: Feb. 23, 2007

(51) Int. Cl. H04L 9/00

(52) U.S. Cl. 705/51; 705/77

(57) ABSTRACT

Content communication and purchases using a computer-based media component are described. A tuner component can individually interact with client components, where each communication of content may be varied or configured independent of interactions with other client components. Additionally, content can be purchased using the computer-based media component, where the purchase and/or presentation of the content may utilize the computer-based media component and/or coupled client components.

### BACKGROUND

Despite the prevalence of set-top box personal video recorders (PVRs) and digital video recorders (DVRs), computer-based media systems are gaining increased acceptance. Computer-based media systems utilize a personal computer to decode, decrypt or otherwise receive content, where the content may be stored, presented and/or communicated via the computer system. Inputs to the computer system may be used to adjust the handling and/or presentation of the content.

Unlike set-top box PVRs or DVRs, computer-based media systems may make use of client (or “extender”) systems to provide remote access to content accessed by the computer system implementing the computer-based media system. For example, one or more remote client systems coupled to the computer-based media system may access and present content. Alternatively, the computer-based media system may send communications to coupled client systems.

Although conventional computer-based media systems can provide access to content, the variety of the content is limited. Further, the ability of conventional computer-based media systems to communicate with coupled client systems is limited.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Content communication and purchases using a computer-based media component are described. More specifically, a tuner component can individually interact with client components, where each communication of content (e.g., a graphical user interface, etc.) may be varied or configured independent of interactions with other client components. Additionally, content (e.g., pay-per-view programming, premium programming, etc.) can be purchased using the computer-based media component, where the purchase and/or presentation of the content may utilize the computer-based media component and/or coupled client components.

In one embodiment, a computer-based media component may facilitate individualized communication between a tuner and a remote client component coupled to the tuner via the computer-based media component. Communication attributes may be determined by the computer-based media component and provided to the tuner such that communications from the tuner to the client component may be communicated in accordance with the communication attributes. For example, a communication attribute may represent a unique identifier of the client component, thereby enabling a communication to be routed to the identified client component. Alternatively, the communication attributes may relate to a form of the communication (e.g., a language, a visual format, etc.), a communication protocol used to communicate the communication, a data format used to communicate the communication, etc.

Additional content (e.g., pay-per-view programming, premium programming, etc.) can be purchased using computer-based media components and any remote client components capable of accessing content of the computer-based media component. Consequently, computer-based media components and/or coupled client components may access a wider variety of content. Additionally, billing for the content can be delayed until the content is accessed by the computer-based media component and/or a client component, thereby reducing charges to a user for content that is not received, stored, accessed, etc.

### BRIEF DESCRIPTION OF THE DRAWINGS

The accompanying drawings, which are incorporated in and form a part of this specification, illustrate embodiments and, together with the description, serve to explain the principles of the embodiments:

FIG. 1 shows a block diagram of one embodiment of an exemplar system using a computer-based media component.

FIG. 2 shows a block diagram of one embodiment of an exemplary computer system environment for implementing a computer-based media system.

FIG. 3 shows a flowchart of one embodiment of an exemplary process for communicating content using a computer-based media component.

FIG. 4 shows a flowchart of one embodiment of an exemplary process for determining whether to communicate content using a computer-based media component,

FIG. 5 shows a blood diagram of one embodiment of exemplary communications for communicating content using a computer-based media component.

FIG. 6A shows a flowchart of a first portion of one embodiment of an exemplary process for purchasing content using a computer-based media component.

FIG. 6B shows a flowchart of a second portion of one embodiment of an exemplary process for purchasing content using a computer-based media component.

FIG. 7 shows a block diagram of one embodiment of exemplary communications for purchasing content using a computer-based media component.

### DETAILED DESCRIPTION

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing the terms such as “accepting,” “accessing,” “adding,” “adjusting,” “analyzing,” “applying,” “assembling,” “assigning,” “calculating,” “capturing,” “collecting,” “combining,” “communicating,” “comparing,” “controlling,” “creating,” “defining,” “depicting,” “detecting,” “determining,” “displaying,” “distinguishing,” “establishing,” “executing,” “generating,” “grouping,” “identifying,” “modifying,” “moving,” “outputting,” “performing,” “placing,” “presenting,” “processing,” “programming,” “querying,” “receiving,” “removing,” “repeating,” “requesting,” “sampling,” “selecting,” “sending,” “sorting,” “storing,” “using,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Introduction to the Computer-Based Media Component

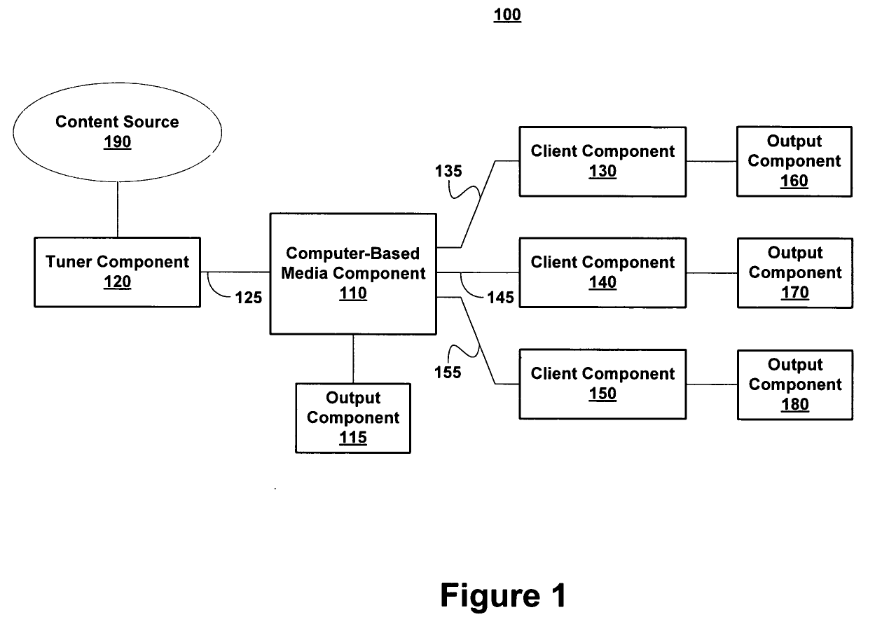

FIG. 1 shows a block diagram of one embodiment of exemplary system 100 using a computer-based media component. As shown in FIG. 1, computer-based media component 110 is coupled to tuner component 120 by interface 125, thereby enabling component 110 to purchase content (e.g., pay-per-view programming, premium programming, etc.) via and/or access content (e.g., graphical user interfaces (GUIs), selectable elements of a GUI, etc.) from tuner component 120. The content may be downloaded from content source 190, or alternatively, generated in whole or in part by a component (e.g., tuner component 120, component 110, etc.) communicating the content. Output component 115 is coupled to component 110 for presenting content transferred from component 110, wherein output component 115 may comprise a display, speaker, or other output device. Additionally, client components 130-150 are coupled to component 110 via interfaces 135-155 for communicating with component 110 and/or tuner component 120 (e.g., to access content from component 110, to purchase content via tuner component 120, etc.). Accessed content may be presented on respective output components 160-180 coupled to client components 130-150, where output components 160-180 may comprise displays, speakers, or other output devices.

Tuner component 120 may comprise hardware and/or software capable of accessing and processing content provided by content source 190, where content source 190 may comprise a content provider (e.g., satellite, cable, etc.), the internet, etc. The content received from content source 190 may comprise video, still images, audio, audio/video data, information related to the content, or other content for access by tuner component 120 or some other component coupled thereto. Processing performed by component 110 may comprise decoding and/or decrypting the information received from content source 190, where the decoding and/or decryption may be performed in accordance with one or more industry standards (e,g., set forth by one or more entities associated with content source 190, tuner component 120, component 110, entities not affiliated with components of system 100, etc.). In one embodiment, tuner component 120 may perform processing necessary to implement a conditional access system (CAS) for providing condition access to the content received from content source 190. Additionally, component 120 may process the content in compliance with one or more digital rights management (DRM) protocols.

In one embodiment, tuner component 120 may comprise a multi-tuner device (MTD) with multiple sub-tuner components, where each sub-tuner component may perform independent access and processing of content provided by content source 190. As such, multiple portions of the content may be accessed (e.g., by component 110, client components 130-150, etc.) via tuner component 120 simultaneously.

Component 110 may comprise hardware and/or software capable of communicating with tuner component 120 (e.g., to enable generation and transfer of customized content intended for client components 130-150, to enable purchase of content, etc.) and/or accessing content from tuner component 120 over interface 125. Interface 125 may comprise a command and control interface enabling communication between tuner component 120 and component 110 in accordance with a broadcast driver architecture (BDA) such as the-Protected Broadcast Driver Architecture (PBDA) from Microsoft Corporation, Redmond, Wash.

As shown in FIG. 1, client components 130-150 may be coupled to component 110 for communication over respective interfaces 135-155, wherein client components 130-150 may comprise hardware and/or software capable of communicating with component 110. Interfaces 135-155 may enable communication between component 110 and a respective client component using one or more different protocols (e.g., TCP/IP, USB 2.0, IEEE 1394, PCI-Express, etc.). In one embodiment, client components 130-150 may implement Media Center Extender devices such as an Xbox 360™ (Microsoft Corporation, Redmond, Wash.), a system comprising hardware and/or software for implementing an Extender device, etc.

Although FIG. 1 shows only three client components (e.g., 130-150) coupled to component 110, a larger or smaller number of client devices may be coupled to component 110 in other embodiments. Additionally, although FIG. 1 shows only one respective output component coupled to component 110 (e.g., output component 115) and client components 130-150 (e,g., output components 160-180), more than one output component may be coupled to any of component 110 and client components 130-150 in other embodiments. Further, although FIG. 1 depicts the components of system 100 (e.g., 110, 120, 130-150, 190, etc.) as separate components, one or more of the components of system 100 may be combined in other embodiments.

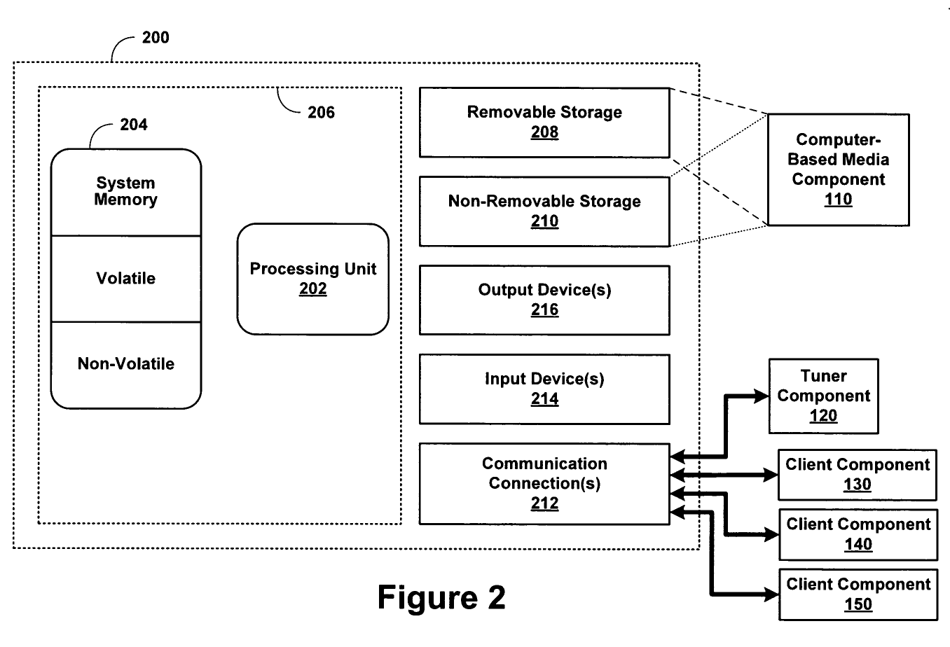

FIG. 2 shows a block diagram of one embodiment of exemplary computer system environment 200 for implementing a computer-based media system. In its most basic configuration, computer system environment 200 may include at least one processing unit 202 and at least one memory 204. Depending on the exact configuration and type of computer system environment, memory 204 may be volatile (e.g., RAM), non-volatile (e.g., ROM, flash memory, etc.), or some combination of the two. This most basic configuration is depicted in FIG. 2 by dashed line 206. Additionally, computer system environment 200 may also have additional features and/or functionality. For example, computer system environment 200 may also include additional storage (e.g., removable, non-removable, etc.) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computer system environment 200. Any such computer storage media may be part of computer system environment 200.

Computer system environment 200 may also contain communication connection(s) 212 that allow it to communicate with other devices. Communication connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. Computer system environment 200 may also have input device(s) 214 such as a keyboard, mouse, pen, voice input device, touch input device, etc. Output device(s) 216 such as a display, speakers, printer, etc. may also be included. All these devices are well known in the art and need not be discussed at length here.

Embodiments are described in terms of these example environments. Description in these terms is provided for convenience only. It is not intended that the embodiments be limited to application in this example environment. After reading the following description, a person skilled in the relevant art will recognize how to implement alternative embodiments.

As shown in FIG. 2, tuner component 120 and client components 130-150 may couple to communication connection(s) 212 of computer system environment 200. Additionally, computer-based media component 110 may comprise instructions stored within removable storage 208 and/or non-removable storage 210. Accordingly, when executed (e.g., by processing unit 202), the instructions of component 110 may enable communication of content (e.g., a graphical user interface, etc.) from tuner component 120 to one or more client components (e.g., 130-150) in accordance with embodiments described herein. Alternatively, execution of the instructions of component 110 may enable purchase of content (e.g., pay-per-view programming, premium programming, etc.) via tuner component 120, where the content may then be accessed by computer system environment 200, any of client components 130-150, etc. for presentation via coupled output components or devices (e.g., 115, 160-180, 216, etc.).

### Content Communication Using a Computer-Based Media Component

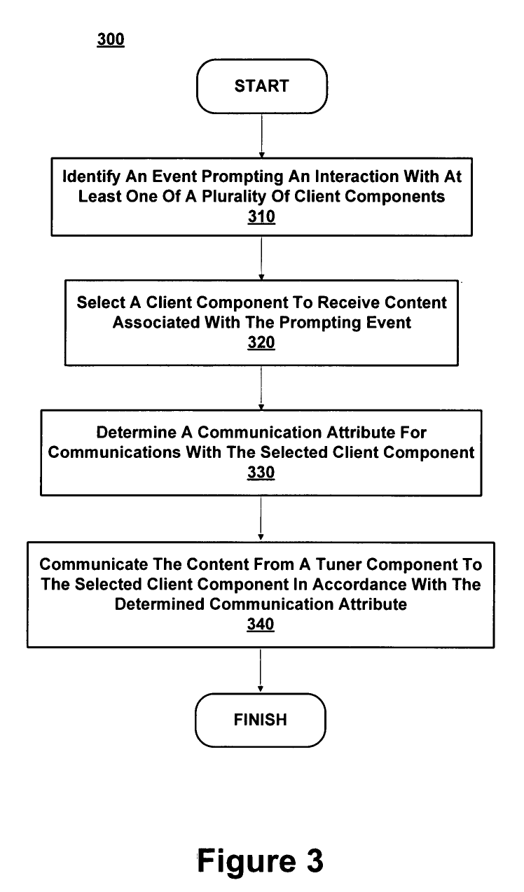

FIG. 3 shows a flowchart of one embodiment of exemplary process 300 for communicating content using a computer-based media component. As shown in FIG. 3, step 310 involves identifying an event that prompts an interaction with at least one of a plurality of client components (e.g., 130-150 of FIG. 1). The event may comprise at least one of an error related to said content (e.g., content unavailable, access to content is restricted or denied, etc.), an error related to a communications component for communicating the content (e.g., an error associated with content source 190, tuner component 120, component 110, etc.), an alert related to said content (e.g., delay in presentation of content, additional features available in conjunction with the content, etc.), an alert related to a communications component for communicating the content (e.g., new software/firmware upgrade available, component characteristic requiring user attention, etc.).

Step 320 involves selecting a client component to receive content associated with the prompting event. The selection of the client component (e.g., 130, 140, 150, etc.) may be based upon relevance of the content to a client component (e.g., a current state thereof), or alternatively, the selection may be arbitrary (e.g., selection of all client components, a predetermined grouping of client components, etc.). The content to be communicated to the selected client component may comprise a displayable message, a GUI, a selectable element of a GUI (e.g., a button), etc. Additionally, the content may be associated with the prompting event (e.g., a message related to a detected error or alert). Further, the content may be accessed from a content source (e.g., 190) and/or generated in whole or in part by a component (e.g., tuner component 120, component 110, etc.) communicating the content.

As shown in FIG. 3, step 330 involves determining a communication attribute for communications with the selected client component. The communication attribute may comprise a unique identifier for the selected client component. Alternatively, the attribute may relate to at least one of a form (e.g., a language, a visual format, etc.) of the communications to the selected client component, a communication protocol (e.g., TCP/IP, USB 2.0, IEEE 1394, PCI-Express, etc.) used to communicate the content to the selected client component, and a data format (e.g., XML, HTML, MCML, etc.) of the content communicated to the selected client component which may be different from a data format used to communicate content to at least one other client component. Further, in one embodiment, the communication attribute may be determined by a computer-based media component (e.g., 110) implemented on a computer system (e.g., 200) which is communicatively-coupled to the selected client component.

Step 340 involves communicating the content from a tuner component (e.g., 120) to the selected client component (e.g., 130, 140, 150, etc.) In accordance with the determined communication attribute. In one embodiment, the content may be communicated by a computer-based media component (e.g., 110) implemented on a computer system (e.g., 200) which is communicatively-coupled to the selected client component. Additionally, the content may be communicated in accordance with more than one communication attribute in other embodiments. As such, embodiments provide convenient and effective mechanisms for communicating different content to different client components (e.g., by assigning a different communication attribute comprising a unique client component identifier to each selected client component) and for independently varying and/or configuring the communications (e.g., by assigning different communication attributes related to the form of the communication, the protocol of the communication, etc.).

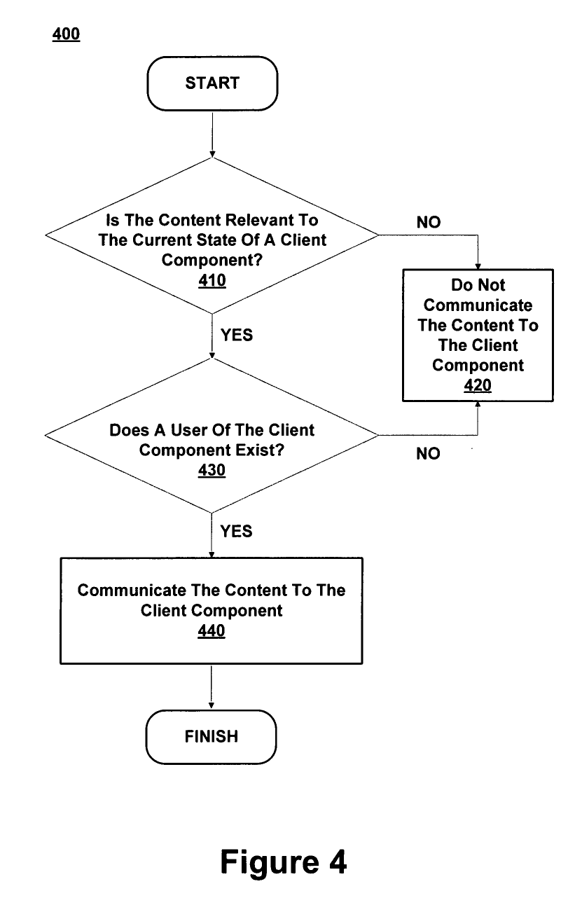

FIG. 4 shows a flowchart of one embodiment of exemplary process 400 for determining whether to communicate content using a computer-based media component. In one embodiment, process 400 may be used to determine the relevance of the content to a client component in step 320 of process 300, where the outcome of process 400 may determine whether a client component should be selected to receive the content.

As shown in FIG. 4, step 410 involves determining whether the content is relevant to a current state of a ellent component. For example, if the content relates to a specific portion of a user interface menu presented on the client component (e.g., a help dialogue box) and the client component is currently presenting another portion of the user interface menu (e.g., a user has moved to a different location in the hierarchy since the occurrence of the prompting event), then the content may no longer be relevant to the client component. As such, if it is determined in step 410 that the content is not relevant to the current state of the client component, then the content may not be communicated to the client component in step 420. Alternatively, if it is determined in step 410 that the content is relevant to the current state of the client component, then step 430 may be performed.

Step 430 involves determining whether a human user of the client component is present. In one embodiment, the presence of a user may be indicated by a characteristic of the client component. For example, if the client component is setup to run automated code, then it may be determined that a user is not present. In another embodiment, a user may not be present if a predetermined period of time has elapsed since the last user interaction with the client component. If it is determined that a user is not present, then the content may not be communicated to the client component in step 420.

Alternatively, if it is determined in step 430 that a human user is not present, then the content may be communicated to the client component in step 440. In one embodiment, step 440 may comprise determining at least one communication attribute for the communication (e.g., as in step 330 of FIG. 3) and then communicating the content to the client component in accordance with the at least one determined communication attribute (e.g., as in step 340 of FIG. 3).

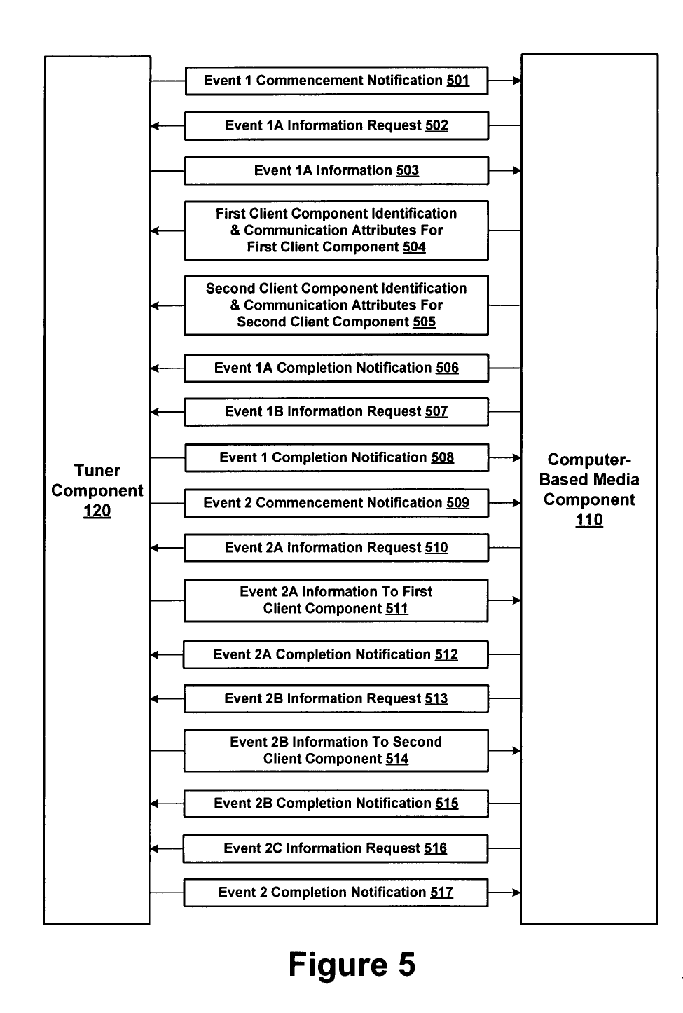

FIG. 5 shows a block diagram of one embodiment of exemplary communications for communicating content using a computer-based media component. As shown in FIG. 5, various communications (e.g., 501-517) are transmitted between tuner component 120 and computer-based media component 110, where the communications may be transmitted over interface 125 shown in FIG. 1. The communications may be transmitted in response to identification of a prompting event which prompts an interaction with one or more client components (e.g., as in step 310 of FIG. 3). Additionally, as depicted in FIG. 5, communications 501-508 are directed to a first event which may involve selecting client components to receive communications from tuner component 120 (e.g., as discussed in step 320 of FIG. 3) and determining communication attributes for those communications (e.g., as discussed in step 330 of FIG. 3). Communications 509-517 are directed to a second event which may involve communicating the content in accordance with the determined communication attributes (e.g., as discussed in step 340 of FIG. 3). In the example of FIG. 5, the first and second events associated with communications 501-517 occur in response to the prompting event, and are therefore distinct from the prompting event.

As shown in FIG. 5, communication 501 is a commencement notification for the first event transmitted from tuner component 120 to component 110. In one embodiment, the first event may be commenced by tuner component 120 calling an “Event: PendingEvent” action.

Communication 502 is an information request for event 1A sent from component 110 to tuner component 120. In one embodiment, the information request may be initiated by component 110 calling a “GetEvent( )” action with arguments for which values are sought by component 110. In one embodiment, arguments such as “EventID,” “EventType,” “EventData,” and “Result” may be used in a call which may be represented as “Get Event(&EventID, &EventType, &EventData, &Result).” The EventID argument may be used to uniquely identify the current event (e.g., event 1A as depicted in FIG. 5). Additionally, the EventType argument may identify the type of event. The EventData argument may be used to specify data for the event. Additionally, the Result argument may be used to indicate a status of the event (e.g., successfully completed) or indicate an error.

As shown in FIG. 5, communication 503 is a response sent from tuner component 120 to component 110 providing information about event 1A. In one embodiment, communication 503 may comprise argument values for the arguments specified in communication 502, where one or more of the arguments may have a null value (e.g., indicated by a “0,” by a lack of a value for a given argument, etc.). For example, tuner component 120 may respond with the following values: EventID=122, EventType=BroadcastMMI, EventData=, and Result=SUCCESS. Accordingly, the returned argument values, may indicate that event 1A is assigned an event identifier of “122,” event 1A is associated with identifying client components to receive date for use in presenting an man-machine interface (MMI), event data (e.g., additional communication attributes) is not provided for event 1A, and the communication was successful.

Communication 504 is transmitted from component 110 to tuner component 120, where communication 504 may identify a first client component and indicate communication attributes for communicating with the first client component. In one embodiment, component 110 may call the following actions: “SetCurrentLanguage(“ENG-US”, &Result); OpenBroadcastMMI(EventID=122, DialogRequest=500, &Result).” As such, the actions and argument values may indicate that the first client component is assigned a unique identifier (e.g., represented as a “DialogRequest” value) of 500 and that communications with the first client component shall be in English.

As shown in FIG. 5, communication 505 is transmitted from component 110 to tuner component 120, where communication 506 may identify a second client component and indicate communication attributes for communicating with the second client component. In one embodiment, component 110 may call the following actions: “SetCurrentLanguage(“SPA-MX”, &Result); OpenBroadcastMMI(EventID=122, DialogRequest=501, &Result).” As such, the actions and argument values may indicate that the second client component is assigned a unique identifier (e.g., represented as a “DialogRequest” value) of 501 and that communications with the second client component shall be in Spanish.

Communication 506 is a completion notification for event 1A transmitted from component 110 to tuner component 120. In one embodiment, component 110 may call the following action: “CompleteEvent(EventID=122, EventResult=SUCCESS, &Result).”

As shown in FIG. 5, communication 507 is an information request for event 1B sent from component 110 to tuner component 120. In one embodiment, the information request may be initiated by component 110 calling the following action: “Get Event(&EventID, &EventType, &EventData, &Result).”

Communication 508 is a completion notification for event 1 transmitted from tuner component 120 to component 110. In one embodiment, tuner component 120 may respond with an argument value of “ERROR_NO_MORE_EVENTS” for the Result argument. As such, tuner component 120 may indicate to component 110 that event 1 has come to an end.

As shown in FIG. 5, communication 509 is a commencement notification for the second event transmitted from tuner component 120 to component 110. In one embodiment, the second event may be commenced by tuner component 120 calling an “Event: PendingEvent” action.

Communication 510 is an information request for event 2A sent from component 110 to tuner component 120. In one embodiment, the information request may be initiated by component 110 calling the following action: “Get Event(&EventID, &EventType, &EventData, &Result).”

As shown in FIG. 5, communication 511 is a response sent from tuner component 120 to component 110 providing information for event 2A for use by the first client component. For example, tuner component 120 may respond with the following values: EventID=123, EventType=OpenMMI, EventData=(dialog_number=12345, dialog_request=500, dialog_type=SimpleHTML, FullScreen, dialog_data=“http://<MTD IP Addr>/<MTD MMI path>”), and Result=SUCCESS. Accordingly, the returned argument values may indicate that event 2A is assigned an event identifier of “123,” event 2A comprises communicating data to client components for use in presenting a MMI, additional communication attributes are provided for event 2A, and the communication was successful. The event data values (e.g., additional communication attributes) may indicate that the communication has been assigned a unique identifier of “12345,” the communication is directed to the first client component (e.g., as indicated by the dialog_request value of “500”), the data format for the communication is HTML, the resulting interface shall occupy a substantial portion of the output component coupled to the first client component, and the data used to generate the interface may be located at a given address (e.g., from the internet, a memory coupled to component 110, etc.).

Communication 512 is a completion notification for event 2A transmitted from component 110 to tuner component 120. In one embodiment, component 110 may call the following action: “CompleteEvent(EventID=123, EventResult=SUCCESS, &Result).”

As shown in FIG. 5, communication 513 is an information request for event 2B sent from component 110 to tuner component 120. In one embodiment, the information request may be initiated by component 110 calling the following action: “Get Event(&EventID, &EventType, &EventData, &Result).”

Communication 514 is a response sent from tuner component 120 to component 110 providing information for event 2B for use by the first client component. For example, tuner component 120 may respond with the following values: EventID=124, EventType=OpenMMI, EventData=(dialog_number=12346, dialog_request=501, dialog_type=SimpleHTML, FullScreen, dialog_data=“http://<MTD IP Addr>/<MTD MMI path>”), and Result=SUCCESS. Accordingly, the returned argument values may indicate that event 2B is assigned an event identifier of “124,” event 2B comprises communicating data to client components for use in presenting a MMI, additional communication attributes are provided for event 2B, and the communication was successful. The event data values (e.g., additional communication attributes) may indicate that the communication has been assigned a unique identifier of “12346,” the communication is directed to the second client component (e.g., as indicated by the dialog_request value of “501”), the data format for the communication is HTML, the resulting interface shall occupy a substantial portion of the output component coupled to the second client component, and the data used to generate the interface may be located at a given address (e.g., from the internet, a memory coupled to component 110, etc.).

As shown in FIG. 5, communication 515 is a completion notification for event 2B transmitted from component 110 to tuner component 120. In one embodiment, component 110 may call the following action: “CompleteEvent(EventID=124, EventResult=SUCCESS, &Result).”

Communication 516 is an information request for event 2C sent from component 110 to tuner component 120. In one embodiment, the information request may be initiated by component 110 calling the following action: “Get Event(&EventID, &EventType, &EventData, &Result).”

As shown in FIG. 5, communication 517 is a completion notification for event 2 transmitted from tuner component 120 to component 110. In one embodiment, tuner component 120 may respond with an argument value of “ERROR_NO_MORE_EVENTS” for the Result argument. As such, tuner component 120 may indicate to component 110 that event 2 has come to an end.

In summary, multiple and perhaps unspecified formats can be used for MMI interactions, while also allowing one device (e.g., tuner component 120) to communicate with multiple clients in, for example, their own languages. Accordingly, MMIs and other communications can be individualized per client component (e.g., 130, 140, 150, etc.), where the communications may occur in accordance with communication attributes that are flexible and configurable.

### Content Communication Using a Computer-Based Media Component

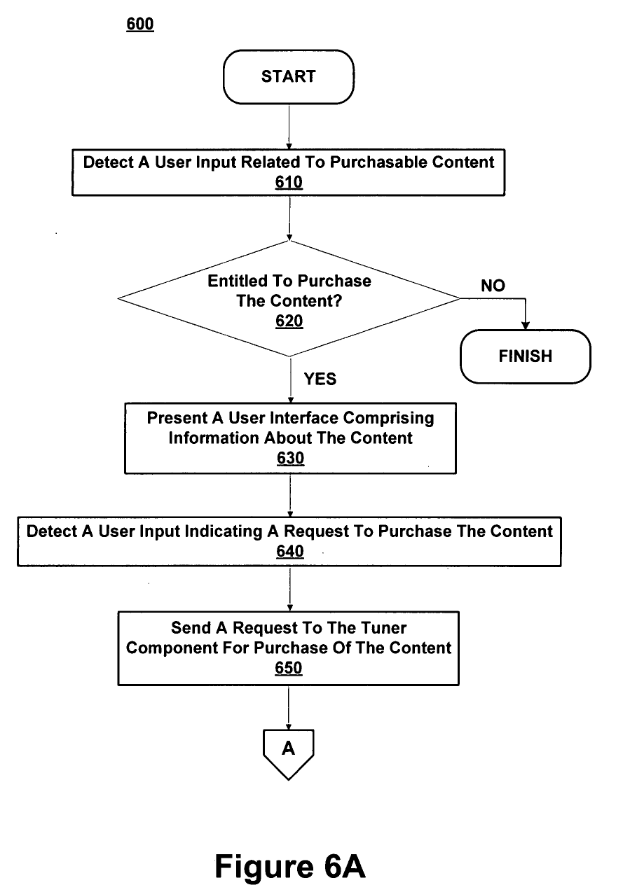

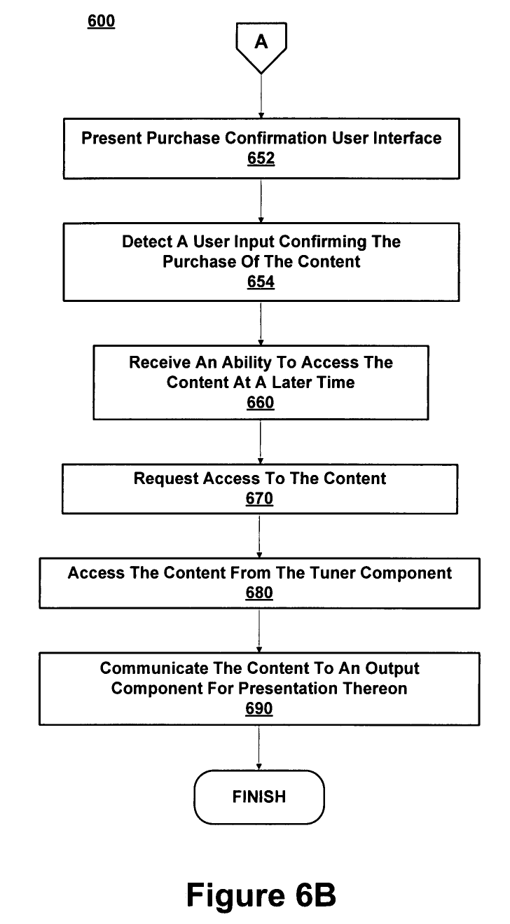

FIGS. 6A and 6B show flowcharts of one embodiment of exemplary process 600 for purchasing content using a computer-based media component in accordance with one embodiment. As shown in FIG. 6A, step 610 involves detecting a user input related to purchasable content. The user input may comprise any interaction with a computer-based media component (e.g., 110) and/or a client component (e.g., 130, 140, 150, etc.,) coupled to the computer-based media component, where the interaction involves access to any information related to purchasable content. For example, the user input detected in step 610 may comprise a user-initiated scrolling of a displayed program guide such that information (e.g., channel number, channel name, content name, content rating, content price, available content access time, etc.) related to at least one pay-per-view, premium, or other purchasable content is displayed. Alternatively, the user input (e.g., scrolling through a guide) may display a message such as “purchase required” indicating that the content must be purchased before access is permitted.

Step 620 involves determining whether an account related to the computer-based media component or the client component coupled to the computer-based media component is entitled to purchase the content (e.g., related to the user input detected in step 610). In one embodiment, the account may be related to a component (e.g., either the computer-based media component or a coupled client component) which receives the user input in step 610. The account may represent a relationship with a user of the component (e.g., computer-based media component 110 and/or coupled client component 130, 140, 150, etc.) and a content providers (e.g., represented by content source 190 in FIG. 1). As such, the account may be entitled to purchase the content if the account has sufficient credit for the purchase in one embodiment. In another embodiment, the account may be entitled to purchase the content if the user (e.g., associated with the user input in step 610) meets predetermined user access requirements (e.g., age, user access privileges, etc.). In other embodiments, satisfaction of one or more requirements may entitle the account to purchase the content. Further, in one embodiment, the determination may be executed by sending data, referred to herein as an “entitlement token,” from a computer-based media component (e.g., 110) to a tuner component (e.g., 120), where the entitlement token may provide the identity and/or characteristics of a user, account or component (e.g., 110, 130-150, etc.) for use in determining whether the account is entitled to access the content. Accordingly, if it is determined in step 620 that the account is not entitled to purchase the content, then process 600 may terminate. Alternatively, if it is determined in step 620 that the account is entitled to purchase the content, then step 630 may be performed,

As shown in FIG. 6A, step 630 involves presenting a user interface comprising information about the content. In one embodiment, the user interface may be that referred to in the discussion of step 610, where the user interface may now present information used to purchase the purchasable content. For example, the user interface may present windows, buttons, or other graphical elements (e.g., reading “purchase,” “purchase now,” etc.) enabling a user to request the purchase of the content. Additionally, the user interface may be presented on an output component (e.g., 115) of a computer-based media component in one embodiment. In another embodiment, the user interface may be presented on an output component (e.g., 160, 170, 180, etc.) of a client component (e.g., 130, 140, 150, etc.) coupled to the computer-based media component (e.g., 110). Further, the data used to generate the user interface may be communicated from the tuner component (e.g., 120) with data used to purchase the content, which is referred to herein as a “purchase token.”

Step 640 involves detecting a user input indicating a request to purchase the content. In one embodiment, the user input may be received by a computer-based media component (e.g., 110). Alternatively, the user input may be received by a client component (e.g., 130, 140, 150, etc.) coupled to the computer-based media component (e.g., 110). Additionally, in one embodiment, the user input indicating the request may comprise activation or selection of a selectable graphical element of the user interface presented in component (e.g., 120) for purchase of the content. The request may be communicated from a computer-based media component (e.g., 110), where, for example, the user input detected in step 640 is input to the computer-based media component. Alternatively, the request may be communicated from a client component (e.g., receiving the user input indicating the request in step 640) to a tuner component (e.g., 120) via a computer-based media component (e.g., 110). Additionally, in one embodiment, the request may comprise communication of a purchase token for the content to the tuner component (e.g., 120).

As shown in FIG. 6B, step 652 involves presenting a purchase confirmation user interface. The purchase confirmation user interface may comprise one or more selectable graphical elements for enabling a user to confirm the purchase of the content. The user interface may be presented on an output component (e.g., 115) of a computer-based media component in one embodiment. In another embodiment, the user interface may be presented on an output component (e.g., 160, 170, 180, etc.) of a client component (e.g., 130, 140, 150, etc.) coupled to the computer-based media component (e.g., 110). Additionally, the purchase confirmation user interface may be generated by the computer-based media component (e.g., 110) in one embodiment. In another embodiment, the purchase confirmation user interface may be communicated from the tuner component (e.g., 120), where, for example, the communication may occur in response to a purchase confirmation user interface interaction requested by the tuner component.

Step 654 involves detecting a user input confirming the purchase of the content. In one embodiment, the user input may be received by a computer-based media component (e.g., 110). Alternatively, the user input may be received by a client component (e.g., 130, 140, 150, etc.) coupled to the computer-based media component (e.g., 110). Additionally, in one embodiment, the purchase confirmation user input may comprise activation or selection of a selectable graphical element of the user interface presented in step 652.

As shown in FIG. 6B, step 660 involves receiving an ability to access the content at a later time. The ability to access the content at a later time may be represented by data, referred to herein as a “capture token,” and may be communicated to the computer-based media component (e.g., 110) for subsequent use by either the computer-based media component or a client component (e.g., 130, 140, 150, etc.) coupled to the computer-based media component (e.g., 110).

Step 670 involves requesting access to the content. The request may be in response to a user input received by the computer-based media component or a client component (e.g., 130, 140, 150, etc.) coupled to the computer-based media component (e.g., 110). The request may be communicated by either the computer-based media component or a client component (e.g., 130, 140, 150, etc.) coupled to the computer-based media component (e.g., 110). Additionally, the request may comprise communication of a capture token for the content to the tuner component (e.g., 120).

As shown in FIG. 6B, step 680 comprises accessing the content from the tuner component (e.g., 120). The content may be accessed by either the computer-based media component or a client component (e.g., 130, 140, 150, etc.) coupled to the computer-based media component (e.g., 110). Additionally, in one embodiment, access of the content may initiate billing of the account for access to the content. As such, embodiments enable delayed billing (e.g., beyond the time of purchase in step 650) to account for situations in which the content is not accessed (e.g., power outage, hardware failure, missed showing of content, etc.), thereby reducing charges to the account for content not accessed, stored, presented, etc.

Step 690 comprises communicating content to an output component for presentation thereon. In one embodiment, the output component (e.g., 115) may be that associated with a computer-based media component (e.g., 110). In another embodiment, the user interface may be presented on an output component (e.g., 160, 170, 180, etc.) of a client component (e.g., 130, 140, 150, etc.) coupled to the computer-based media component (e.g., 110).

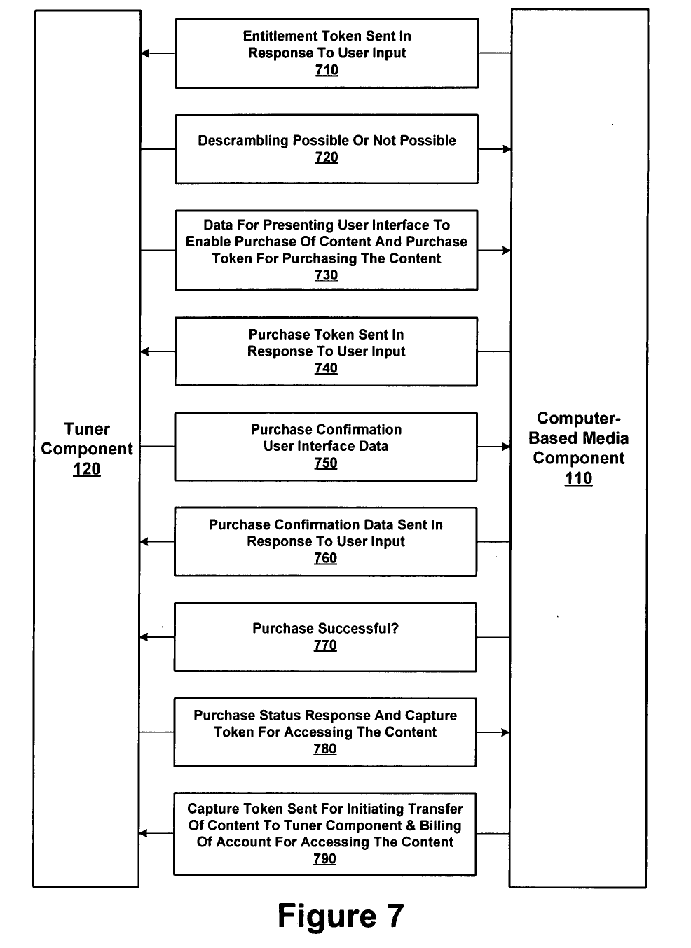

FIG. 7 shows a block diagram of one embodiment of exemplary communications for purchasing content using a computer-based media component. As shown in FIG. 7, various communications (e.g., 710-790) are transmitted between tuner component 120 and computer-based media component 110, where the communications may be transmitted over interface 125 shown in FIG. 1.

As shown in FIG. 7, communication 710 comprises an entitlement token sent from component 110 to tuner component 120 in response to a user input. The user input may be associated with purchasable content. In one embodiment, the user input may be that detected in step 610 of FIG. 6A. Further, in one embodiment, the entitlement token may be sent in response to component 110 calling the following action: “CheckEntitlementToken(DialogRequest=1234, RequestType=2, EntitlementToken=token from Guide, &DescrambleStatus, &UDRIResult).” As such, the action may indicate which computer-based media component or client component is sending the entitlement token, the intended use of the entitlement token (e.g., identified by the value of “2”), and an identification of the content to be purchased (e.g., identified by the value of “token from Guide”). Values for the RequestType argument may indicate intended uses, of the entitlement token such as to determine why certain content is not accessible (e.g., using a value of “1”), to request that the tuner component check entitlement for purchase of certain content (e.g., using a value of “2”), and to indicate the tuner component shall not disrupt streaming to act on the entitlement token (e.g., using a value of “3”).

Communication 720 is an indication of whether tuner component 120 is able to descramble the content received (e.g., from content source 190 of FIG. 1). In one embodiment, communication 720 may be sent in response to tuner component 120 calling the following action: “DescrambleStatus=1; UDRIResult=SUCCESS_MMI_PENDING).” As such, the action may indicate to component 110 that tuner component 120 is able to descramble the purchasable content (e.g., upon subsequent purchase of the content). Alternatively, the value of “0” for the DescrambleStatus argument may indicate that descrambling is not possible (e.g., from which component 110 may then use to present an appropriate user interface to a user indicating that the content may not be purchased).

As shown in FIG. 7, communication 730 is data for presenting a user interface to enable purchase of the content as well as data comprising a purchase token for use in purchasing the content, where communication 730 is sent to component 110 from tuner component 120. The data (e.g., metadata, etc.) may be sent in XML format for presentation on an output component coupled to either component 110 or a client component (e.g., 130, 140, 150, etc.) coupled to component 110. In one embodiment, the data may be sent in response to tuner component 120 calling the following action: “Event: MmiOpen; dialog_number=5678; dialog_request=1234; dialog_type=Purchase Entitlement UUID; dialog_data=xml including the purchase token; CloseMmiDialog(dialog_number=5678).” As such, the communication may indicate that the communication is an MMIOpen event with various event data values. The event data values (e.g., additional communication attributes) may indicate that the communication has been assigned a unique identifier of “5678,” the communication is directed to a component (e.g., 110, 130-150, etc.) with an identifier of “1234,” the communication provides data for presenting a purchase entitlement UUID, and the data comprises information used to generate the interface as well as a purchase token for use in purchasing the content.

Communication 740 comprises a purchase token sent from component 110 to tuner component 120 in response to a user input requesting purchase of the content. In one embodiment, the purchase token may be sent in response to component 110 calling the following action: “PurchaseEntitlement(PurchaseToken=PurchaseToken, DialogRequest=1234, &DescrambleStatus, &CaptureToken, &Result).” As such, the action may indicate that a purchase token is sent for purchase of the content associated with the purchase token, where the purchase token is sent by a component (e.g., 110, 130-150, etc.) with an identifier of “1234.”

As shown in FIG. 7, communication 750 is purchase confirmation user interface data sent from tuner component 120 to component 110 to enable presentation of a purchase confirmation user interface (e.g., as discussed above with respect to step 652 of FIG. 6B). In one embodiment, this communication may not be sent if component 110 provides data (e.g., to an output component coupled to either component 110 or a client component coupled to component 110) to present the purchase confirmation user interface.

Communication 760 is purchase confirmation data sent from component 110 to tuner component 120 to confirm the purchase of the content. In one embodiment, communication 760 may be sent in response to a user input as discussed above with respect to step 654 of FIG. 6B.

As shown in FIG. 7, communication 770 is a query sent from component 110 to tuner component 120 to determine whether the purchase of the content was successful. In one embodiment, the query may be sent in response to component 110 calling the following action: “PurchaseEntitlement(PurchaseToken=PurchaseToken, DialogRequest=0, &DescrambleStatus, &CaptureToken, &Result).” As such, the value of “0” provided for the DialogRequest argument may be used to indicate a query as to the success of the content purchase (e.g., using the purchase token).

Communication 780 is a purchase status response as well as data comprising a capture token for use in accessing the content, where communication 780 is sent to component 110 from tuner component 120. In one embodiment, tuner component 120 may send the following argument values: “Result=SUCCESS, DescrambleStatus=0×01, CaptureToken=Capture Token.” As such, the argument values sent by tuner component 120 may indicate that the purchase of the content was successful, that tuner component 120 is able to descramble the content (e.g., thereby making it possible for component 110 to process the content upon receipt from tuner component 120), and that a capture token for accessing the content at a later time is provided with communication 780.

As shown in FIG. 7, communication 790 comprises a capture token sent from component 110 to tuner component 120 for initiating transfer of the content to tuner component 110. Additionally, communication 790 may indicate a request to bill the account (e.g., associated with component 110, a client component coupled to component 110, etc.) for access to the content (e.g., upon initiating the transfer, upon successful completion of the transfer, etc.).

In summary, content can be purchased by, for example, a tuner component (e.g., 120) under control of a computer-based media component (e.g., 110) and/or a component (e.g., 130, 140, 150, etc.) coupled to the computer-based media component. In addition to the content, metadata and/or information describing the content may be transmitted from the tuner component (e.g., 120) to the computer-based media component (e.g., 110) and/or the component (e.g., 130, 140, 150, etc.) coupled to the computer-based media component.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A method of communicating content from a tuner component to at least one client component of a plurality of client components, said method comprising:
identifying an event that prompts an interaction with said at least one client component;
selecting a client component to receive said content, wherein said content is associated with said prompting event;
determining a communication attribute for communications with said client component; and
communicating said content from said tuner component to said client component in accordance with said determined communication attribute.

2. The method of claim 1, wherein said content comprises at least one of a displayable message, a graphical user interface (GUI), and a selectable element of a GUI.

3. The method of claim 1, wherein said prompting event comprises at least one of an error related to said content, an error related to a communications component for communicating said content, an alert related to said content, and an alert related to a communications component for communicating said content.

4. The method of claim 1, wherein said communicating is performed by a computer-based media component implemented on a computer system, said computer system communicatively-coupled with said client component.

5. The method of claim 1, wherein said communication attribute comprises a unique identifier for said client component.

6. The method of claim 1, wherein said communication attribute relates to at least one of a form of said communication to said client component, a communication protocol used to communicate said content to said client component, and a data format of said content communicated to said client component which is different from a data format used to communicate paid content to at least one other client component.

7. The method of claim 1, wherein said selecting a client component further comprises:
determining whether said content is relevant to a current state of said client component; and
communicating said content to said client component only if said content is relevant.

8. A method of purchasing content using a computer-based media component, said method comprising:
presenting a user interface comprising information about said content;
detecting a user input indicating a request to purchase said content; and
in response to said detected user input, sending a request from said computer-based media component to a tuner component for purchase of said content.

9. The method of claim 8 further comprising:
determining whether an account related to at least one of said computer-based media component and a client component coupled to said computer-based media component is entitled to purchase said content; and
if said account is entitled to purchase said content, communicating data from said tuner component to said computer-based media component for presentation of said user interface comprising information about said content.

10. The method of claim 8 further comprising:
upon purchase of said content, receiving an ability to access said content at a future time;
requesting access to said content; and
accessing said content from said tuner component, wherein access to said content initiates billing of an account associated with said computer-based media component.

11. The method of claim 8, wherein said user interface is presented on an output component associated with said computer-based media component, and wherein said user input indicating an intent to purchase said content is received by said computer-based media component.

12. The method of claim 8, wherein said user interface is presented on an output component associated with a client component coupled to said computer-based media component, and wherein said user input indicating an intent to purchase said content Is received by said client component.

13. The method of claim 8 further comprising:
communicating said content to an output component for presentation thereon, wherein said output component is associated with at least one of said computer-based media component and a client component coupled to said computer-based media component.

14. A computer-usable medium having computer-readable program code embodied therein for causing a computer system to perform a method of communicating content between a tuner component and a plurality of client components, said method comprising:
accessing content from said tuner component;
determining at least one communication attribute for communications between said tuner component and a select client component of said plurality of client components; and
communicating said content from said tuner component to said select client component in accordance with said at least one communication attribute determined for said select client component.

15. The computer-usable medium of claim 14, wherein said determined communication attribute comprises a unique identifier for said select client component.

16. The computer-usable medium of claim 14, wherein said method further comprises:
identifying an event that prompts an interaction with at least one of said plurality of client components; and
selecting said select client component to receive said content, wherein said content is associated with said prompting event.

17. The computer-usable medium of claim 16, wherein said communication attribute relates to at least one of a form of said communication to said select client component, a communication protocol used to communicate said content to said select client component, and a data format of said content communicated to said select client component which is different from a data format used to communicate said content to at least one other client component.

18. The computer-usable medium of claim 16, wherein said selecting said select client component further comprises:
determining whether said content is relevant to a current state of said select client component; and
communicating said content to said select client component only if said content is relevant.

19. The computer-usable medium of claim 14, wherein said method further comprises:
communicating data to said select client component for presentation of a user interface on said select client component, wherein said data comprises information about purchasable content for presentation on said select client accessing said content from said tuner component upon purchase thereof; and
communicating said content to said select client component for presentation thereof.

20. The computer-usable medium of claim 19, wherein said method further comprises:
determining whether said select client component is entitled to purchase said content; and
if said select client component is entitled to purchase said content, communicating data to said select client component for presentation of a user interface on said select client component to enable purchase of said content.
